(19) United States
(12) Patent Application Publication
(10) Pub. No.: US 2008/0080511 A1
(43) Pub. Date: Apr. 3, 2008

(54) Buffer cluster structure and arbiter scheme for multi-port upper-layer network processor

(76) Inventors: Jian-Guo Chen, Basking Ridge, NJ (US); Cheng Gang Duan, Shanghai (CN); Lin Hua, Shanghai (CN)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/540,929

(22) Filed: Sep. 28, 2006

(51) Int. Cl. H04L 12/56

(52) U.S. Cl. 370/392

(57) ABSTRACT

Apparatus and methods for receiving data packets from a plurality of physical networks are disclosed. For example, in given embodiment, an example apparatus can include a plurality of data pipelines each adapted to receive data packets from a respective physical network and a single analysis device adapted to receive packet header data and characteristic information from each of the plurality of data pipelines to perform packet identification for each received data packet.

### BACKGROUND

In a networked communication system, when a packet of data is received by a terminal attached to the network, a number of known processes occur. First, the entirety of the packet is stored in a data buffer. Next, the packet header and/or certain portions of the packet payload are extracted so as to perform certain analysis functions, such as packet identification and data integrity validation. If the analysis verifies the packet as legal and its data valid, the packet will be transferred to a corresponding upper network layer for further utilization; otherwise, the packet will be dropped from the buffer.

For network terminals attached to multiple networks, however, new processing problems can arise. If the network terminal is software based, then a single processor will typically be used to service each network to perform data extraction, identification and verification for every packet of every network. Unfortunately, the software approach is often too slow for practical applications. While faster network terminals may be made from gate-level logic to achieve the necessary processing speed, the redundant circuitry needed to perform all the required tasks can be prohibitively expensive.

Thus, new technology related to providing fast and inexpensive network terminals is desirable.

### SUMMARY

In an illustrative embodiment, an apparatus for receiving data packets from a plurality of physical networks includes a plurality of data pipelines each adapted to receive data packets from a respective physical network of the plurality of physical networks, wherein each received data packet includes header data and payload data, and a single analysis device adapted to receive at least one of header data and characteristic information of the received data packets from each of the plurality of data pipelines and perform a packet identification function for each received data packet.

In another illustrative embodiment, an apparatus for receiving data packets from a plurality of physical networks includes a plurality of data pipelines each adapted to receive data packets from a respective physical network of the plurality of physical networks, wherein each received data packet includes header data and payload data, and an analysis means coupled to each data pipeline for performing validation and identification functions on data packets provided via each data pipeline.

In another illustrative embodiment, a method for processing data packets from a plurality of physical networks includes receiving multiple data packets from each of a plurality of physical networks, wherein each received data packet includes header data and payload data, storing each received data packet using a respective data pipeline and performing data analysis on each of the received data packets using a single analysis device to derive identification and validation information for each received packet.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is an exemplary communication system in accordance with an illustrative embodiment.

FIG. 2 depicts details of the exemplary data pipeline of FIG. 1 in accordance with an illustrative embodiment.

FIG. 3 depicts details of the exemplary data buffers of FIG. 2 in accordance with an illustrative embodiment.

FIG. 4 is a flowchart outlining an exemplary process for efficiently receiving and processing data packets in accordance with an illustrative embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

The various advantages offered by the disclosed methods and systems include providing an improved communication system that provides superior performance to software-based alternatives and substantial cost benefits as compared to gate-level logic alternatives.

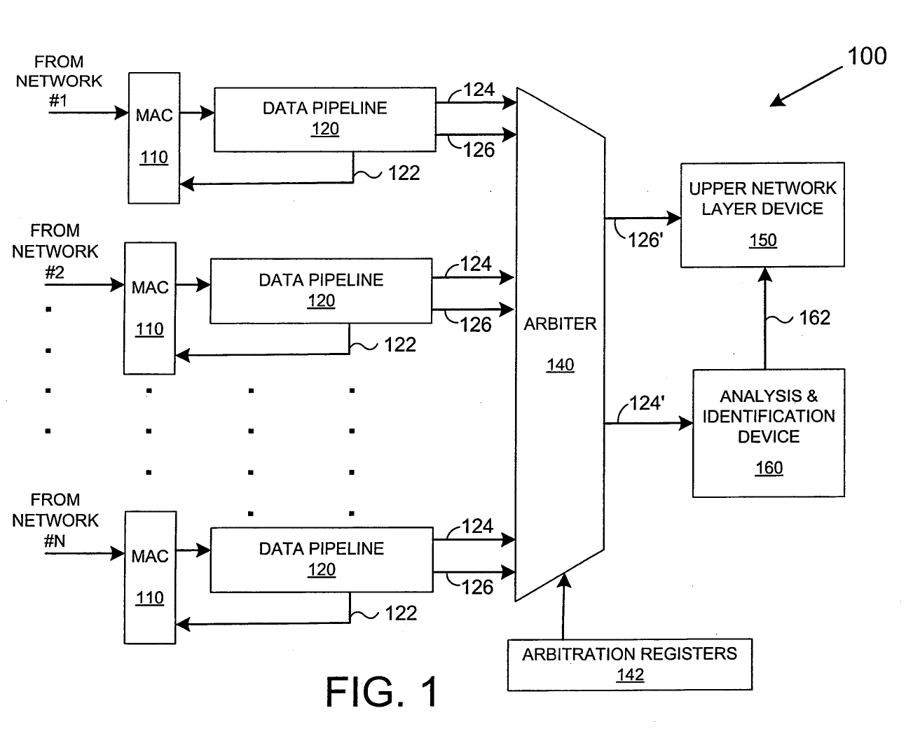

FIG. 1 is an exemplary communication system 100 in accordance with an illustrative embodiment capable of receiving data packets derived from multiple networks. In various embodiments, the networks can be of the same type, e.g., four different Ethernet networks or from a combination of different types of networks, e.g., Ethernet networks, Universal Serial Bus (USB) networks, wireless networks (e.g., 802.11 or Bluetooth), Firewire networks and so on.

As shown in FIG. 1, the communication system 100 includes a plurality of media access controllers (MACs) 110 each coupled to a respective data pipeline 120. The various data pipelines 120, in turn, are coupled to an analysis and identification device 160 and to an upper network layer device 150 via an arbiter 140.

In operation, any of the MACs 110 can receive data packets from a respective network via a physical (PHY) device (not shown).

Upon receiving a data packet, a MAC 110 can forward the packet to its respective data pipeline 120. Given that the communication system 100 of FIG. 1 has N different MACs 110 with N respective pipelines 120, it should be appreciated that each of the MACs 110 and respective pipelines 120 can operate independent of one another. Thus, any activity on Network #1 should not burden those MACs 110 and pipelines 120 not connected to Network #1 with any extra processing.

As a pipeline 120 receives a data packet from its respective MAC 110, the pipeline 120 can extract various types of characteristic information from the header of each packet, such as Ethernet network type, Internet Protocol version, network level four type and packet length. Note, however, that in various embodiments and with evolving communication standards, it should be appreciated that the type of characteristic information extracted from a packet header can vary and may be limited only to that information residing in a variety of different packet headers. For example, should a new wireless standard evolve having a variety of versions, then it can be beneficial to include a set of parameters delineating the new wireless standard versions as part of the characteristic information.

In addition to extracting characteristic information from a packet header, the data pipelines 120 can store the received data packets in first data buffer (not shown) to await further processing while a second data buffer (also not shown) can be used to store the extracted characteristic information.

As the received data packets with their respective characteristic information are stored in the various data pipelines 120, the arbiter 140, under control of the arbitration registers 142, can control the flow of data packets (with extracted characteristic information) from the various data pipelines 120 to the analysis and identification device 160. For example, in one embodiment an external microcontroller can set the arbitration registers 142 to cause the arbiter 140 to give priority to a specific data pipeline 120 while in another embodiment the arbitration registers 142 can be set to cause the arbiter 140 to use a rotating priority scheme. In still other embodiments, however, it should be appreciated that the priority scheme implemented by the arbiter 140 and arbitration registers 142 can vary to encompass any known or later developed functional arbitration scheme, such as fixed priority, rotating priority, time-slice arbitration, arbitration based on past network activity and so on.

As a data packet with its extracted characteristic information is received by the analysis and identification device 160, the analysis and identification device 160 can perform a number of specific tasks for the packet that may include: (1) determining whether the payload data in the data packet is valid or corrupted (e.g., a verify that a checksum is correct); (2) identifying whether the source of the packet is valid/recognized; (3) identifying whether the packet is related to a valid/known function; (4) identifying whether the packet is related to an ongoing established function of the upper layer network device 150; and (5) identifying whether the data packet should be further analyzed to establish a new function.

For example, assuming that an external terminal wishes to establish a new MPEG data stream, the external terminal could send an initial data packet with an embedded request to start downloading a specific file containing the requisite MPEG data. In response, the analysis and identification device 160 can first determine whether the payload data of the initial packet is valid or corrupted. Assuming that the payload data is valid, the analysis and identification device 160 could determine that the data packet is not related to any ongoing function. However, assuming that certain other conditions are met, such as that the source of the data packet is recognized as a valid terminal, the analysis and identification device 160 can make the determination that the data packet should undergo further analysis and consideration by the upper layer network device 150. Assuming that the upper layer network device 150 establishes a new MPEG data steam based on the initial data packet, the upper layer network device 150 can configure the analysis and identification device 160 to recognize subsequent data packets related to the new MPEG data stream. Subsequently, those data packets received from the external terminal and related to the new MPEG data stream can be handled completely by the analysis and identification device 160.

Note that as the arbiter 140 provides data packets (with extracted characteristic information) to the analysis and identification device 160, the arbiter 140 can concurrently provide the same data packets to the upper layer network device 150. For the example of FIG. 1, the links 124 from each data pipeline 120 can be coupled to link 124′ leading to the analysis and identification device 160 to provide a first path for data packets. Similarly, the links 126 from each data pipeline 120 can be coupled to link 126′ leading to the upper layer network device 150 to provide a second, parallel data path. While in various embodiments both links 124 and 126 can carry identical information, in the present example of FIG. 1, link 124 is adapted to carry both data packets and characteristic information while link 126 generally carries either data packets or only the payload data of packets.

Continuing, as the analysis and identification device 160 completes its verification and identification tasks, the analysis and identification device 160 can provide an appropriate signal to the upper layer network device 150 via link 162 to indicate that the analyzed packet is valid/corrupted, as well as provide any identifying information.

Returning to the pipelines 120, as data packets are provided from the various data pipelines 120 to the analysis and identification device 160, it should be appreciated that the act of arbitration may cause the available data capacity of a particular data pipeline 120 to drop below a critical level. Accordingly, when a data pipeline reaches a threshold of “fullness”, the data pipeline 120 can send a “backpressure signal” to its respective MAC 100 via link 122. In turn, the respective MAC 110 can send various control signals over its respective network to inhibit further data packets from being transmitted to the communication system 100. Similarly, when the available data capacity of a data pipeline 120 rises above a given threshold data, the data pipeline 120 can send another backpressure signal to its respective MAC indicating that data flow to the communication device 100 can be increased.

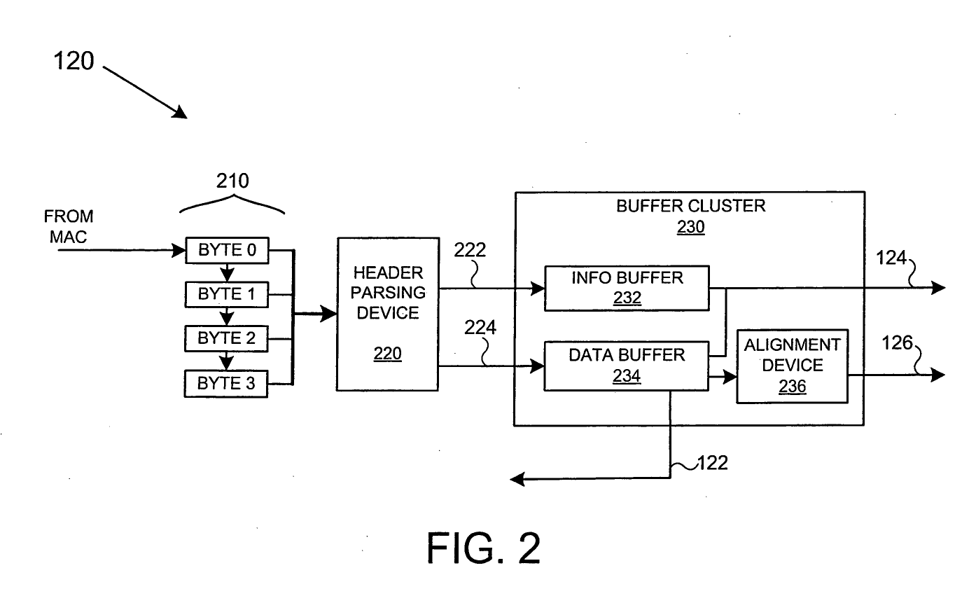

FIG. 2 depicts details of an exemplary data pipeline 120 of FIG. 1 in accordance with an illustrative embodiment. As shown in FIG. 2, the data pipeline 120 includes a receiving data buffer 210 consisting of four byte-wide memories (that together form a 32-bit word), a header parsing device 220 and a buffer cluster 230. The buffer cluster 230 includes a characteristic information buffer 232, a packet data buffer 234 and an alignment device 238.

In operation, the receiving data buffer 210 can receive a data packet one byte at a time from a respective MAC, form the received data into 32-bit words, and deliver the 32-bit words to the header parsing device 220.

As the header parsing device 220 receives the various 32-bit words for a given packet, the header parsing device 220 can extract characteristic information from the header of the received packet and deliver the characteristic information to the information buffer 232 via link 222. Simultaneously, the header parsing device 220 can forward the entirety of the data packet to the data buffer 234 via link 224.

Those data packets received by the data buffer 234 can be temporarily stored within its internal memory. Similarly, the extracted characteristic information may be temporarily stored within the internal memory of the information buffer 232.

In response to a control signal from an external arbitration device (such as the arbiter 140 of FIG. 1), the buffer cluster 230 can combine a data packet stored in the data buffer 234 with a set of respective characteristic information parameters stored in the information buffer 232, and deliver the combined information to an external analysis device (not shown).

Concurrently, the buffer cluster 230 can also send the same data packet directly to another external device, or alternatively deliver the data packet via the alignment device 236. When data is sent via the alignment device 236, the alignment device 236 can remove the data packet's header, realign the payload data such that its first bit aligns on a 32-bit word boundary and provide zero padding at the end of the payload data in those instances where the payload data does not completely fill the last 32-bit word.

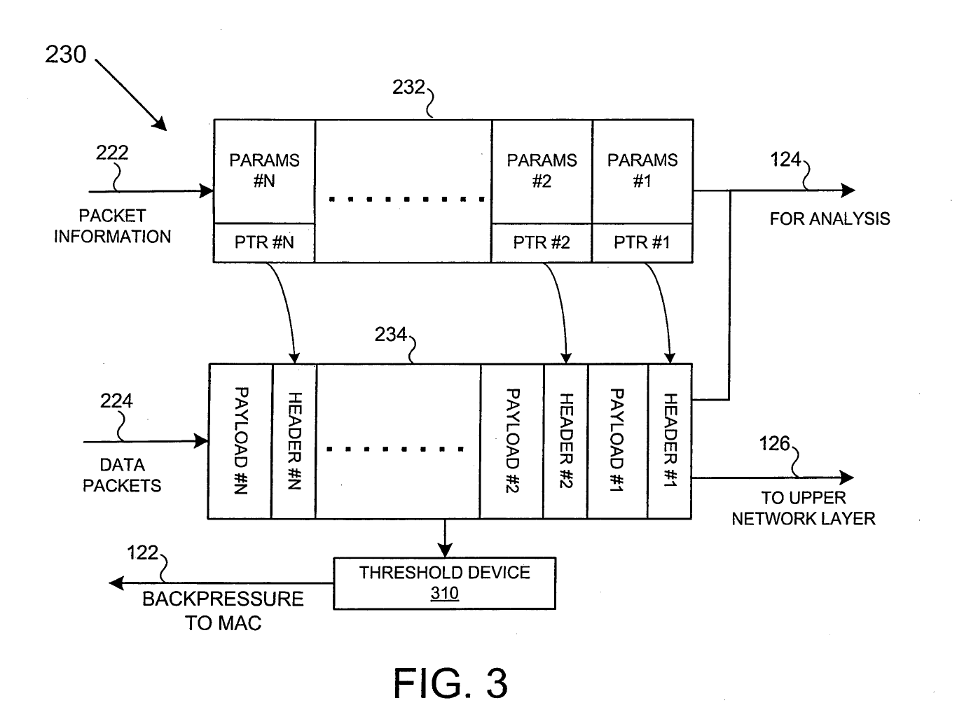

FIG. 3 depicts details of the exemplary data buffers 232 and 234 of FIG. 2 in accordance with an illustrative embodiment. As shown in FIG. 3 the data buffer 234 can carry a number of data packets #1 . . . #N, which are shown in FIG. 3 as delineated into header data blocks and payload data blocks. A threshold device 310 coupled to the data buffer 234 can monitor the amount of data currently occupying the data buffer 234 to provide an appropriate backpressure signal to a MAC.

As is also shown in FIG. 3, the information buffer 232 is adapted to store sets of characteristic information parameters PARAMS for each packet. In various embodiments, the characteristic information parameters PARAMS can be used to identify a packet's characteristic information, which as mentioned above can relate to issues such as Ethernet network type, Internet Protocol version, network level four type, packet length and so on.

In addition to the characteristic information parameters PARAMS, the information buffer 232 can include a data pointer PTR identifying/pointing to the starting address of a respective data packet stored in the data buffer 234. By using the parameters PARAMS and pointers PTR in the information buffer 232, the management, movement and processing of the data packets can be more easily managed.

While the exemplary data buffers 232 and 234 are first-in-first-out (FIFO) devices, it should be appreciated that various other memory architectures, such as circular buffers, stacks, dual-port memories and so on might also be used with various impacts upon overall performance.

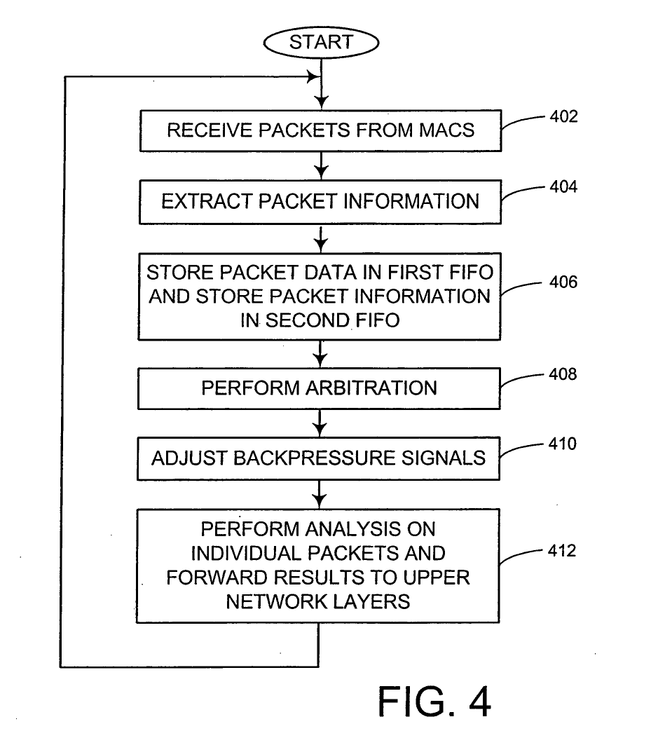

FIG. 4 is a flowchart outlining an exemplary process for efficiently receiving and processing data packets in accordance with an illustrative embodiment. The process starts in step 402 where a variety of data packets can be received from a plurality of MACs servicing separate physical networks. Next, in step 404, characteristic information of each packet can be extracted from the received data packets. Then, in step 406, the various received data packets can be stored in a first FIFO (or other memory type) buffer while the characteristic information can be stored in a second FIFO (or other memory type) buffer. Note that in various embodiments, steps 402-406 can be performed using a different pipeline device for each MAC. Control continues to step 408.

In step 408, an arbitration process can be performed on the various received data packets based on a number of arbitration rules, such as the source network of a packet and a set of arbitration rules. Next, in step 410, a backpressure signal can be generated based on the available capacity (“fullness”) of a pipelined device and provided to a respective MAC. The respective MAC, in turn, can inhibit or advance network traffic in an attempt to prevent overloaded or underutilized data buffers. Control continues to step 412.

In step 412, an analysis procedure can be performed on each data packet in an order determined by the arbitration process in step 408, optionally by a single analysis device, and the results of each data analysis procedure can be forwarded to a device operating on a higher network level. Control then jumps back to step 402 where more data packets can be received and processed.

The many features and advantages of the present teachings are apparent from the detailed specification, and thus, it is intended by the appended claims to cover all such features and advantages of the present teachings which fall within the true spirit and scope of the present teachings. Further, since numerous modifications and variations will readily occur to those skilled in the art, it is not desired to limit the present teachings to the exact construction and operation illustrated and described, and accordingly, all suitable modifications and equivalents may be resorted to, falling within the scope of the present teachings.

1. An apparatus for receiving data packets from a plurality of physical networks, comprising:
a plurality of data pipelines each adapted to receive data packets from a respective physical network of the plurality of physical networks, wherein each received data packet includes header data and payload data; and
a single analysis device adapted to receive at least one of header data and characteristic information of the received data packets from each of the plurality of data pipelines and perform a packet identification function for each received data packet.

2. The apparatus of claim 1, wherein the analysis device is further adapted to receive payload data of the received data packets from each of the plurality of data pipelines and perform a data validation using the received payload data.

3. The apparatus of claim 1, further comprising an arbiter disposed between the plurality of data pipelines and the analysis device, the arbiter being adapted to arbitrate data flow from the data pipelines to the analysis device based on a set of one or more data arbitration rules.

4. The apparatus of claim 1, wherein each data pipeline includes:
a receiving data buffer coupled to a respective media access controller (MAC);
a header parsing unit coupled to the receiving data buffer and adapted to extract characteristic information of each received data packet; and
at least one first-in-first-out (FIFO) buffer adapted to temporarily store the received data packets.

5. The apparatus of claim 2, wherein each data pipeline includes a first data buffer adapted to temporarily store payload data from each received data packet.

6. The apparatus of claim 5, wherein the first data buffer is adapted to temporarily store both header data and payload data for each received data packet.

7. The apparatus of claim 6, further comprising a second data buffer adapted to temporarily store the characteristic information of each received data packet.

8. The apparatus of claim 7, wherein the characteristic information includes at least two of packet length, Ethernet type, Internet Protocol version, network level four type and packet length.

9. The apparatus of claim 8, wherein the second data buffer is further adapted to store pointers pointing to memory locations in the first buffer.

10. The apparatus of claim 7, further comprising a header parsing unit that derives the characteristic information from the header data of each received packet and provides the characteristic information to the second buffer.

11. The apparatus of claim 5, wherein the first data buffer of each data pipeline is adapted to produce a backpressure feedback signal to a respective media access controller (MAC) when the first buffer reaches a predetermined level of fullness.

12. The apparatus of claim 2, wherein the analysis device is further adapted to provide information relating to an analysis of a received packet to a device operating at an upper network layer.

13. The apparatus of claim 2, wherein the arbiter is adapted to concurrently provide packet payload data to both the analysis device and to a device operating at an upper network layer.

14. The apparatus of claim 1, wherein the apparatus is adapted to simultaneously communicate with at least an Ethernet network, a universal serial bus and a Firewire network.

15. An apparatus for receiving data packets from a plurality of physical networks, comprising:
a plurality of data pipelines each adapted to receive data packets from a respective physical network of the plurality of physical networks, wherein each received data packet includes header data and payload data; and
a single analysis means coupled to each data pipeline for performing validation and identification functions on data packets provided via each data pipeline.

16. The apparatus of claim 15, further comprising an arbitration means for arbitrating data flow from each data pipeline to the analysis means.

17. The apparatus of claim 15, wherein each data pipeline includes a means for temporarily storing payload data and for providing backpressure signals to a respective media access controller (MAC).

18. A method for processing data packets from a plurality of physical networks, comprising:
receiving multiple data packets from each of a plurality of physical networks, wherein each received data packet includes header data and payload data;
storing each received data packet using a respective data pipeline; and
performing data analysis on each of the received data packets using a single analysis device to derive identification and validation information for each received packet.

19. The method of claim 18, further comprising performing an arbitration process on the stored data packets to determine an order in which the stored data packets are analyzed.

20. The method of claim 19, further comprising controlling at least one media access controller (MAC) to inhibit data packet reception on a respective physical network.
